(19) United States
(12) Patent Application Publication
(10) Pub. No.: US 2024/0265200 A1
(43) Pub. Date: Aug. 8, 2024

(54) CONVERSATION DEVICE AND TRAINING DEVICE THEREFOR

(71) Applicant: National Institute of Information and Communications Technology, Tokyo (JP)

(72) Inventors: Kentaro TORISAWA, Tokyo (JP); Ryu IIDA, Tokyo (JP); Junta MIZUNO, Tokyo (JP); Jonghoon OH, Tokyo (JP); Julien KLOETZER, Tokyo (JP); Yoshihiko ASAO, Tokyo (JP); Mana KAMAKURA, Tokyo (JP)

(73) Assignee: National Institute of Information and Communications Technology, Tokyo (JP)

(21) Appl. No.: 18/562,774

(22) PCT Filed: May 18, 2022
(86) PCT No.: PCT/JP2022/020648

§ 371 Date: Nov. 20, 2023

(30) Foreign Application Priority Data
May 28, 2021 (JP) 2021-090300

(51) Int. Cl. G06F 40/20

(52) U.S. Cl. CPC G06F 40/20

(57) ABSTRACT

A training data generator and a training device include: a supposed input storage storing a plurality of supposed inputs supposed as inputs to a dialogue apparatus; expanded causality DB storing a plurality of causality expressions; a training data preparing unit extracting, for each of the plurality of supposed inputs stored in supposed input storage, a causality expression having a prescribed relation with said supposed input from the plurality of causality expressions, for forming a training data sample having the supposed input as an input and the extracted causality expression as an answer and storing in a training data storage; and a training unit training a response generating neural network designed to generate an output sentence to a natural language input sentence, by using the training data samples stored in training data storage.

### TECHNICAL FIELD

The present invention relates to a dialogue apparatus that uses a computer to interact with a user, a training device therefor and a computer program.

Specifically, the present invention relates to a dialogue apparatus capable of developing topics from a user input, and a training device for training the dialogue apparatus accordingly. The present application claims convention priority on Japanese Patent Application No. 2021-090300 filed on May 28, 2021, and incorporates the descriptions of the Japanese Application in its entirety.

### BACKGROUND ART

Recently, research for dialogue systems based on deep learning has attracting attention, and research and developments of various dialogue system technologies are in progress. Conventional dialogue systems are generally classified to the following three categories.

1) A retrieval-based approach that receives user input, retrieves information from some database that is not necessarily for dialogue, based on the information obtained from the user input, and utilizes the results. Deep learning techniques may be used for selecting and processing retrieved results.

2) An approach that automatically generates response sentence or sentences from user input. Deep-learning-based end-to-end method is an example of this approach. Patent Literature 1 listed below adopts this approach.

In this method, dialogue data is obtained from dialogue logs from, for example, on-line chat services. Using the dialogue data, learning mainly using the deep learning techniques is conducted so that the system automatically generates responses to the input.

3) A scenario-based approach. This approach is used in many so-called AI (Artificial Intelligence) speakers.

### CITATION LIST

### Patent Literature

PTL 1: JP2018-156272A

### SUMMARY OF INVENTION

### Technical Problem

According to the first approach above, information obtained as responses is limited within the scope of the database. Further, the relation between a user input and the response is not very clear to the user, so that the dialogue with the user does not tend to develop.

The second approach above has a problem that the generated results output as responses are uncontrollable. Deep learning inherently has a problem that the process of generating a response from an input is invisible. Therefore, it is not clear how to control the response. Further, in this approach, it is necessary to collect a huge amount of dialogue data. The scope of coverage thereof must also be extensive. Such collection of data is generally known to be very difficult.

Therefore, the second approach above has a problem that it is difficult to train the response device to generate a response that develops dialogue from the user input.

The third approach is limited in that the response stays within the scope of a prepared scenario. The dialogue would inevitably be confined within a limited boundary under such constraints.

Therefore, a main object of the present invention is to provide a dialogue apparatus capable of outputting responses that allow development of topics to the user input, as well as to provide a training device that trains the dialogue apparatus accordingly.

### Solution to Problem

According to a first aspect, the present invention provides a training device for a dialogue apparatus, including: a supposed input storage means for storing a plurality of supposed inputs each being supposed as an input to the dialogue apparatus; and a causality storage means for storing a plurality of causality expressions. Each of the plurality of causality expressions includes a cause expression and a result expression.

For each of the plurality of supposed inputs stored in the supposed input storage means, the training device includes: a causality expression extracting means for extracting, from the plurality of causality expressions, a causality expression having a prescribed relation with the supposed input; a training data preparing means for preparing a training data sample having the supposed input as an input and the causality expression extracted by the causality expression extracting means as an answer, and storing it in a prescribed storage device; and a training means for training a dialogue apparatus implemented by a neural network designed to generate an output sentence to an input sentence in a natural language, by using the training data samples stored in the training data preparing means.

Preferably, the causality expression extracting means includes a specific causality expression extracting means for extracting, from the plurality of causality expressions, a causality that its cause expression haves the noun phrase of the supposed input.

More preferably, the training device further includes: a topic word model pre-trained such that when a word is given, context word distribution probability of the word is output for each of the words in a predefined lexicon; and a first training data sample adding means for specifying, for each of the causality expressions of the training data samples stored in the prescribed storage device, a word having a high distribution probability for the word included in the causality expression based on outputs of the topic word model, adding the specified word to the input of the training data sample to generate a new training data sample and adding it to the prescribed storage device.

More preferably, the training device further includes: a second training data sample adding means, extracting, based on an output of the topic word model, for each of the causality expressions of the training data sample stored in the prescribed storage device, a sentence having a context word distribution probability similar to the context word distribution probability of the causality expression from a prescribed corpus, adding the extracted sentence to the input of the training data sample to generate a new training data sample and adding it to the prescribed storage device.

According to a second aspect, the present invention provides a computer program causing a computer to function as a supposed input storage means for storing a plurality of supposed inputs each being supposed as an input to the dialogue apparatus; and a causality storage means for storing a plurality of causality expressions, wherein each of the plurality of causality expressions includes a cause expression and a result expression. The computer program further causes a computer to function as, for each of the plurality of supposed inputs stored in the supposed input storage means, a causality expression extracting means for extracting, from the plurality of causality expressions, a causality expression having a prescribed relation with the supposed input, and a training data preparing means for preparing training data samples having the supposed input as an input and the causality expression extracted by the causality expression extracting means as an answer, and storing them in a prescribed storage device; and further to function as a training means for training a dialogue apparatus implemented by a neural network designed to generate an output sentence to an input sentence in a natural language, by using the training data samples stored in the training data preparing means.

According to a third aspect, the present invention provides a natural language dialogue apparatus, including a neural network designed to generate an output sentence to a natural language input sentence, wherein the neural network is trained such that the output sentence represents a latent result to the input sentence.

Preferably, the dialogue apparatus further includes a related expression adding means, responsive to an input sentence, for adding a related expression, which includes a word or sentence related to the input sentence, to the input sentence and inputting to the neural network.

According to a fourth aspect, the present invention provides a dialogue apparatus, including: an utterance storage storing a past utterance of a user; a topic model for outputting context word occurrence probability distribution with respect to the input word; and a response generator receiving a user utterance as an input, for generating a response to the user utterance by using user utterances stored in the utterance storage and the topic model.

According to a fifth aspect, the present invention provides a dialogue apparatus, including: an utterance storage storing a past utterance of a user; a topic model for outputting context word occurrence probability distribution with respect to the input word; a response generator receiving a user utterance as an input, for generating a response to the user utterance; and a response adjuster adjusting generation of the response by the response generator in accordance with an output of the topic model in response to the user utterance.

The foregoing and other objects, features, aspects and advantages of the present invention will become more apparent from the following detailed description of the present invention when taken in conjunction with the accompanying drawings.

### BRIEF DESCRIPTION OF DRAWINGS

FIG. 1 is a block diagram of a dialogue system that trains a dialogue apparatus in accordance with a first embodiment of the present invention.

FIG. 2 is a block diagram of a training data preparing unit as a part of the dialogue apparatus shown in FIG. 1.

FIG. 3 is a flowchart showing a control structure of a computer program causing a computer to function as the training data preparing device of the dialogue system shown in FIG. 1.

FIG. 4 is a block diagram of a dialogue system that trains a dialogue apparatus in accordance with a second embodiment of the present invention.

FIG. 5. is a block diagram of a training data adding unit shown in FIG. 4.

FIG. 6 is a block diagram of a related expression retrieving unit shown in FIG. 4.

FIG. 7 is a flowchart showing a control structure of a computer program causing a computer to function as the training data preparing device of the dialogue system in accordance with the second embodiment.

FIG. 8 is a flowchart showing a control structure of a routine realizing the related expression adding process shown in FIG. 7.

FIG. 9 is a block diagram showing a dialogue apparatus and a training device for training the dialogue apparatus in accordance with a third embodiment of the present invention.

FIG. 10 shows an example of training data prepared by the training device in accordance with the third embodiment.

FIG. 11 is a flowchart showing a control structure of a computer program causing a computer to function as the training data preparing device of the dialogue system in accordance with the third embodiment.

FIG. 12 is a flowchart showing a control structure of a computer routine realizing the related word adding process shown in FIG. 11.

FIG. 13 is a block diagram of a dialogue apparatus in accordance with a fourth embodiment of the present invention.

FIG. 14 is a block diagram of a dialogue apparatus in accordance with a fifth embodiment of the present invention.

FIG. 15 shows an appearance of a computer system realizing the embodiments above.

FIG. 16 is a block diagram showing hardware configuration of the computer system shown in FIG. 15.

### DESCRIPTION OF EMBODIMENTS

In the following description and in the drawings, the same components are denoted by the same reference characters. Therefore, detailed description thereof will not be repeated.

### I. First Embodiment

### 1 Configuration

### (1) Dialogue System 50

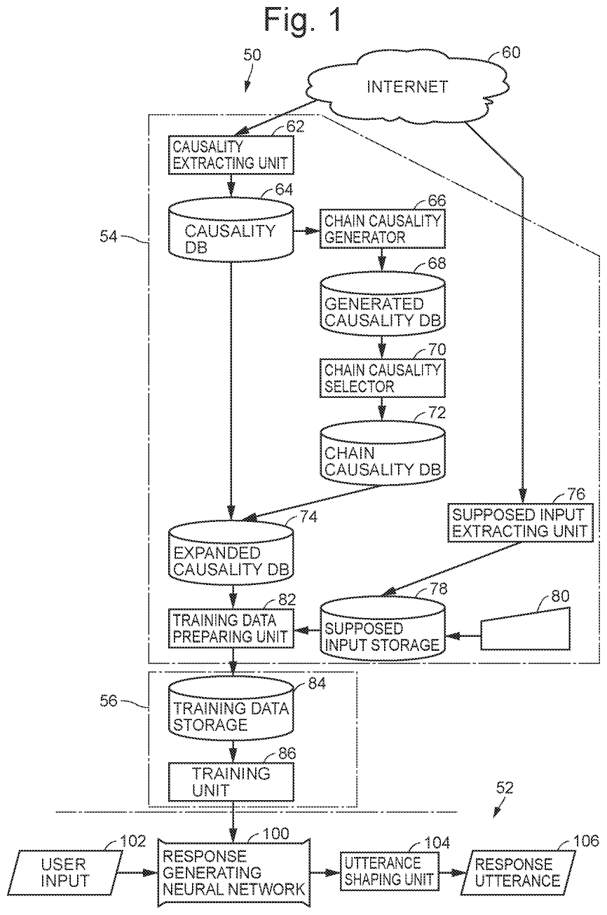

FIG. 1 shows, in a block diagram, configuration of a dialogue system 50 in accordance with the first embodiment of the present invention. Referring to FIG. 1, Dialogue system 50 includes a dialogue apparatus 52 and a training data generator 54 connected to the Internet 60, for generating training data for training dialogue apparatus 52 using causality expressions extracted from the Internet 60. Dialogue system 50 further includes a training device 56 for training dialogue apparatus 52 using the training data generated by training data generator 54.

In the following, configurations of components of dialogue system 50 will be described. It is noted that each of the words forming natural language sentences used in the embodiments below are converted in advance to a word vector. In other words, each natural language sentence is represented as a word vector sequence consisting of word vectors.

### (2) Dialogue Apparatus 52

Dialogue apparatus 52 includes a response generating neural network 100 formed of a neural network that receives user input 102 of natural language sentence, for example, and generates a response sentence. Dialogue apparatus 52 further includes an utterance shaping unit 104 shaping a response sentence output from response generating neural network 100 such that it comes to have an appropriate shape as a response to user input 102 and outputting the result as response utterance 106.

A so-called end-to-end type network pre-trained to generate a response as a natural language sentence to an input of natural language sentence is used as response generating neural network 100. Training of response generating neural network 100 by training device 56 corresponds to so-called fine-tuning.

As response generating neural network 100, a generative network formed of a combination of a transformer encoder and a transformer decoder, or a UniLM prepared by additionally pre-training BERT for generation, for example, may be used. These are not limiting, and any generative network may be used to implement response generating neural network 100. Further, with good amount of generating training data, common generative learning is sufficient for implementation. (Regarding BERT model, see Jacob Devlin, Ming-Wei Chang, Kenton Lee, and Kristina Toutanova. BERT: Pre-training of deep bidirectional transformers for language understanding.)

### (3) Training Data Generator 54

Training data generator 54 includes: a causality extracting unit 62 for extracting causality expressions by a known method from the Internet 60; and causality DB (database) 64 for storing causality expressions extracted by causality extracting unit 62. Training data generator 54 further includes: a chain causality generator 66 for linking, when a result part of one causality (first causality) is semantically matching a cause part of another causality (second causality) among the causality expressions stored in causality DB 64, the cause part of the first causality to the result part of the second causality, and further linking the thus generated new causality to a still another causality to generate a chain of new causality candidates; and generated causality DB 68 for storing candidates of causality generated by chain causality generator 66. For the extraction of causality by causality extracting unit 62, causality recognition method disclosed in JP 2018-060364A, for example, may be used. As a method of generating new causality candidates by linking causalities, a technique disclosed, for example, in JP2015-121897A may be used.

Training data generator 54 further includes: a chain causality selector 70 selecting that one of the causality candidates stored in generated causality DB 68 which represents an appropriate causality; chain causality DB 72 for storing the causality selected by chain causality selector 70; and expanded causality DB 74 that integrates and stores causalities stored in causality DB 64 and causalities stored in chain causality DB 72.

Training data generator 54 further includes: a supposed input extracting unit 76 extracting expressions supposed to be user input 102 to dialogue apparatus 52 from the Internet 60; and a supposed input storage 78 for storing the supposed inputs extracted by supposed input extracting unit 76 and supposed inputs manually added through a console 80. Training data generator 54 further includes a training data preparing unit 82 for preparing a training data sample, which has any of the supposed inputs stored in supposed input storage 78 as an input and a causality having a result part that can be an answer to the supposed input among the causalities stored in expanded causality DB 74 as a correct answer, and outputting it to training device 56.

As will be described later, training data preparing unit 82 prepares, for each of the supposed inputs read from supposed input storage 78, a training data sample by reading from expanded causality DB 74 such a causality that has as its cause part the noun phrase contained in the corresponding supposed input.

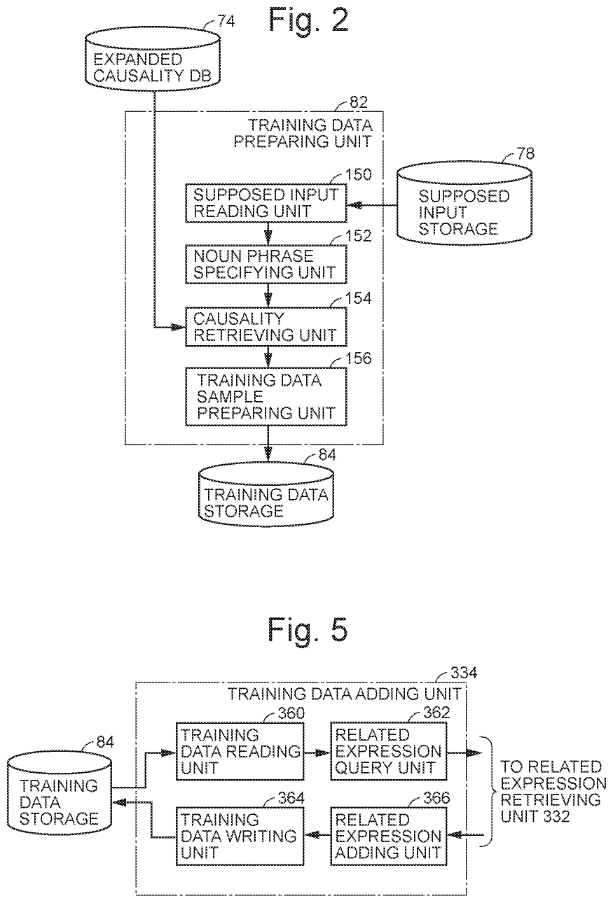

Referring to FIG. 2, training data preparing unit 82 includes: a supposed input reading unit 150 successively reading supposed inputs from supposed input storage 78; and a noun phrase specifying unit 152 for specifying a noun phrase contained in the supposed input read by supposed input reading unit 150. Training data preparing unit 82 further includes: a causality retrieving unit 154 for searching and reading from expanded causality DB 74 every such causality that contains in the result part the noun phrase specified by noun phrase specifying unit 152; and a training data sample preparing unit 156 for preparing, for each causality read by causality retrieving unit 154, a training data sample that has the supposed input as an input and the causality as an output, and for storing it in training data storage 84.

### (4) Training Device 56

Training device 56 includes: a training data storage 84 for storing the training data samples output from training data preparing unit 82; and a training unit 86 for training response generating neural network 100 using the training data samples stored in training data storage 84. The process conducted by training unit 86 on response generating neural network 100 is, as described above, fine tuning of response generating neural network 100. Specifically, for each training data sample, training unit 86 trains response generating neural network 100 through back propagation such that, given a supposed input, response generating neural network 100 comes to generate an output that is a causal consequence of the supposed input.

### (5) Training Data Generating Program

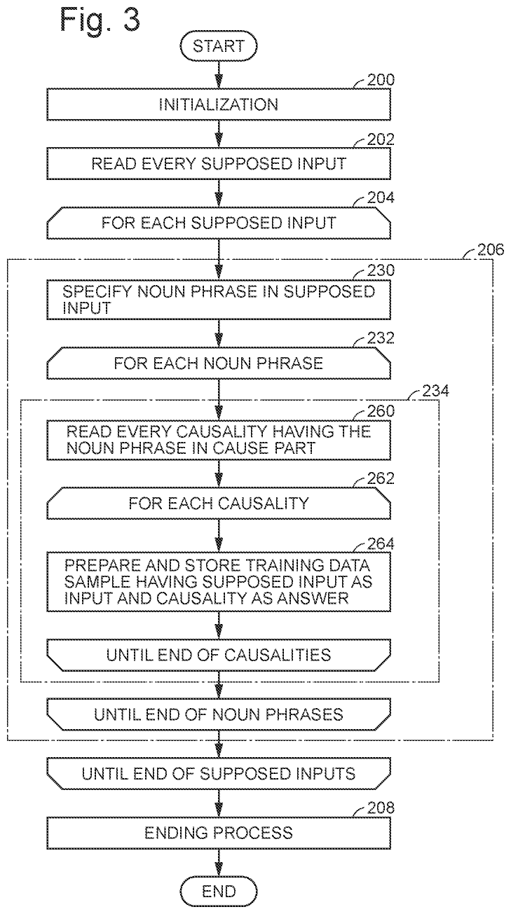

FIG. 3 shows, as a flowchart, a control structure of a computer program that causes a computer to function as training data generator 54. Referring to FIG. 3, the program includes: after activation of the program, a step 200 of securing and initializing a memory area, opening related files and connecting to database; and a step 202 of reading all supposed inputs from supposed input storage 78 shown in FIG. 1. The program further includes: a step 204 of executing a step 206 for each of the supposed inputs read at step 202; and a step 208 of executing, after completion of step 204, a prescribed ending process to end the program.

Step 206 includes: a step 230 of specifying all noun phrases existing in the supposed inputs to be processed; and a step 232 of executing a step 234 for each of the noun phrases specified at step 230.

Step 234 includes: a step 260 of reading all causalities having the noun phrase that is being processed at the cause part from expanded causality DB 74 shown in FIG. 1; and a step 262 of executing a step 264 of preparing, for each of the causalities read at step 260, a training data sample consisting of a combination of the causality with the supposed input that is being processed.

Specifically, at step 264, a training data sample that has the supposed input under processing as an input and the causality under processing as the answer is prepared and stored in training data storage 84 shown in FIG. 1.

### 2 Operation

Dialogue system 50 having the above-described configuration operates in the following manner.

### (1) Training Data Creation

At first, training data generator 54 operates as follows, to create training data for response generating neural network 100. First, causality extracting unit 62 extracts a large number of causalities from the Internet 60, and stores them in causality DB 64. Causality DB 64 stores the causalities in a format allowing various manners of retrieval. By way of example, according to the technique disclosed in JP2018-060364A mentioned above, it is possible to distinguish cause and result parts of a causality. If causality DB 64 is designed to store the cause part and result part of each causality in different columns, it is possible, for example, to easily extract only those causalities that contain a specific word in the cause part.

Chain causality generator 66 generates all possible causality pair candidates from the causalities stored in causality DB 64, in which the result part of the first causality has substantially the same meaning of the cause part of the second causality. By linking a plurality of causalities through the same process, new causality candidates are generated. In the present embodiment, causalities are linked a number of times up to a limit count, so that a large number of causality candidates are generated. These causality candidates are all stored in generated causality DB 68. Generated causality DB 68 stores the causality candidates in, for example, the same manner as causality DB 64. For generated causality DB 68, information specifying the causality from which each causality candidate is generated may be stored together.

The causality candidate generated by chain causality generator 66 is based solely on the fact that between consecutive two causalities in the chain, the result part of one and the cause part of the other are semantically the same. As disclosed in JP2015-121897A mentioned above, among the causality candidates obtained by such chaining of causalities, there are some that do not generally represent correct causalities. Therefore, chain causality selector 70 selects those of the causality candidates stored in generated causality DB 68 which are considered correct, and stores them in chain causality DB 72. Here, as the method of selecting causality candidates, the method disclosed in JP2015-121897A is used. Alternatively, a pre-trained natural language model such as BERT may be fine-tuned and used to select causality candidates.

Expanded causality DB 74 stores causalities obtained by integrating causality DB 64 and chain causality DB 72. Specifically, expanded causality DB 74 stores causalities extracted from the Internet 60 by causality extracting unit 62 and causalities generated from these causalities by chain causality generator 66 and chain causality selector 70. Expanded causality DB 74 also stores the causalities in the similar format as causality DB 64.

On the other hand, similar to causality extracting unit 62, supposed input extracting unit 76 extracts, from a large number of web pages on the Internet 60, expressions considered to be possible inputs to response generating neural network 100 as supposed inputs to response generating neural network 100. By way of example, question sentences of many FAQ (Frequently Asked Questions) sites on the Internet 60 and other question format sentences posted at various sites providing various information may be possible candidates. In addition, it is also possible to extract a normal sentence and to generate a question sentence to which answer includes a noun phrase contained in the extracted sentence. The supposed inputs extracted by supposed input extracting unit 76 are stored in supposed input storage 78.

On the other hand, a user may supplement supposed inputs using console 80. This supplement, however, is not essential.

When the causalities are thus created to be readily available in expanded causality DB 74 and the supposed inputs in supposed input storage 78, respectively, training data preparing unit 82 prepares training data in the following manner. Specifically, a computer executes the program of which control structure is shown in FIG. 3, to create the training data.

Referring to FIG. 3, when this program is activated, first, at step 200, initialization is executed, and at step 202, the supposed inputs stored in supposed input storage 78 are all read and loaded to a memory. At step 204, step 206 is executed as described below, on each of the supposed inputs until the end of supposed inputs, thereby to create the training data.

At step 206, first, every noun phrase in the supposed input that is being processed is specified (step 230), and at step 232, the process of step 234 is executed on each of the noun phrases.

At step 234, for the noun phrase that is being processed, causalities having the noun phrase in the cause part are all extracted from expanded causality DB 74 (step 260). Further, at step 262, for each of these causalities, the process of step 264, that is, the step of preparing a training data sample having the supposed input under processing as the input and having the result part of the causality as an answer and storing the sample in training data storage 84 shown in FIG. 1, is executed repeatedly until all causalities are completed.

When the process of step 232 is completed on every noun phrase specified at step 230, step 206 for a supposed input is complete, and the process of step 206 starts again on the next supposed input.

When step 204 is completed for all the supposed inputs read at step 202, creation of training data ends. The training data are stored in training data storage 84 of FIG. 1.

### (2) Training

Now that the training data are ready as described above, training unit 86 of training device 56 trains response generating neural network 100 using the training data prepared in training data storage 84.

The training of response generating neural network 100 itself is done by common back propagation. Specifically, a supposed input is applied to response generating neural network 100, and an output is obtained from response generating neural network 100. Here, the output of response generating neural network 100 is provided successively in the form of word vectors. Parameters of response generating neural network 100 are adjusted so that a word vector sequence formed by these word vectors should be (the word vector sequence of) the result part of that causality which is the answer of the training data. Since this training is done by a conventional method, details thereof will not be repeated here.

### (3) Dialogue Process

When the training of response generating neural network 100 is complete, it becomes possible to use dialogue apparatus 52. If a user enters any input in natural language, the input is converted to a word vector sequence and given to response generating neural network 100 as user input 102. Response generating neural network 100 generates a response to the user input 102 and outputs it to utterance shaping unit 104. On the response given from response generating neural network 100, utterance shaping unit 104 performs shaping appropriate for a response to user input 102 (for example, adding some expression appropriate for user input 102 at the head, repeating part of user input 102, modifying sentence-end expression to be colloquial, etc.) and outputs the result as a response utterance 106. This shaping may be done on a rule-basis, or a neural network trained by using sentences and the sentences with their endings modified as training data may be used.

A user may provide a speech utterance, and by speech recognition, the utterance may be input as user input 102 to response generating neural network 100. In that case, response utterance 106 may also be provided as a speech, by speech synthesis.

### 3 Effects

Since response generating neural network 100 is trained based on causalities, what is generated by response generating neural network 100 in response to user input 102 becomes sentences related to some causal results to the user input 102. The training data includes causalities generated by chaining causalities. Therefore, typically, not only such answers that can be directly derived from the user input 102 but also sentences related to latent risk or chance derived from the user input 102 may be provided with high possibility as outputs of response generating neural network 100. As a result, dialogue would be more easily developed, as compared with the conventional dialogue systems that retrieve answers from within a certain frame.

In the present embodiment, the training data are created by using causality. While it is difficult to collect a large amount of general dialogue data as done in conventional techniques, it is possible to obtain a huge number of causalities from the Internet using an existing method. Therefore, it is possible to prepare a huge amount of training data, and hence, accuracy of response generating neural network 100 can further be improved. Specifically, in response to user input 102, response generating neural network 100 can generate such an answer based on causality expressions that has high possibility of further developing the dialogue.

In the conventional dialogue system using a neural network, the neural network itself is like a black box. Therefore, it is difficult to describe to the user what the intension of the response output from the dialogue system is. In contrast, in the case of the neural network trained by using causalities such as response generating neural network 100 in accordance with the present embodiment, it is possible to explain that the system is telling chances and risks derived from the user utterance to the user. Therefore, the dialogue system can be regarded not as a mere conversation partner but as a tool that develops user's thinking or drives user's actions, and hence the dialogue system will have a wider field of use.

### II. Second Embodiment

### 1 Configuration

### (1) Dialogue System 300

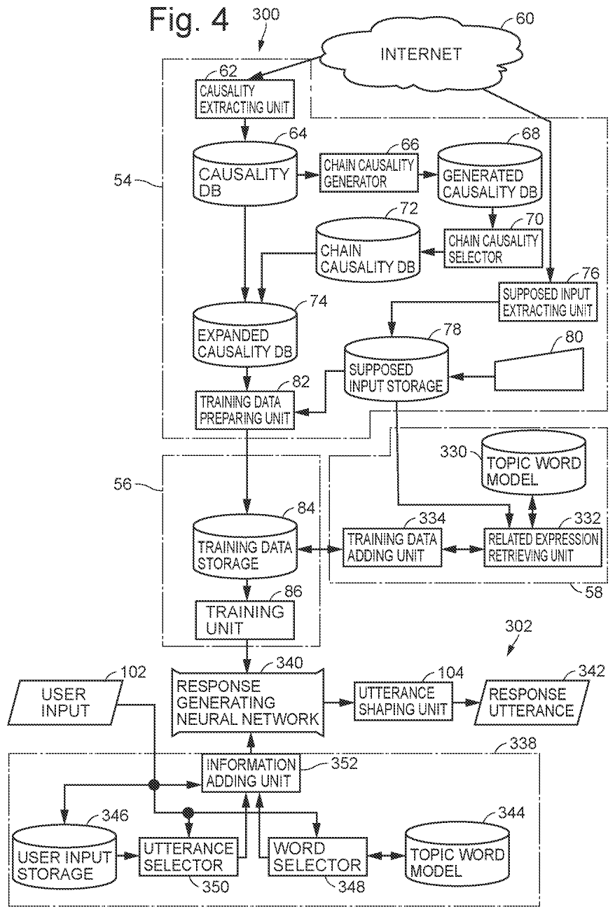

FIG. 4 shows, in a block diagram, the configuration of dialogue system 300 in accordance with the second embodiment of the present invention. Referring to FIG. 4, dialogue system 300 includes training data generator 54 and training device 56 similar to those of the first embodiment. Dialogue system 300 further includes: a training data expansion unit 58, connected to training data storage 84 of training device 56 and to supposed input storage 78 of training data generator 54, for generating a new training data sample for each training data sample, by adding to the supposed input a word/phrase related to the supposed input as a topic, and adding the generated sample to training data storage 84; and a dialogue apparatus 302 that uses a response generating neural network 340 trained by training device 56 using the expanded training data.

Of these, the configuration of training data expansion unit 58 and dialogue apparatus 302 will be described successively in the following.

### (2) Training Data Expansion Unit 58

a. Configuration

Training data expansion unit 58 includes a topic word model 330 prepared by using corpus statistics such that when a word is given, it outputs a context word distribution vector having elements each representing probability of a specific word being generated around the given word. Training data expansion unit 58 further includes a related expression retrieving unit 332 that specifies, when a word is given, a word having a context word distribution vector that is similar to the context word distribution vector of the given word based on the output of topic word model 330, and extracts, from supposed input storage 78, such a supposed input that includes a word having a word vector that is similar to the context word distribution vector of the given word. Training data expansion unit 58 further includes a training data adding unit 334 that extracts, for each training sample data stored in training data storage 84, a word included in the result part of its causality expression and applies it to related expression retrieving unit 332, adds a combination of a word and a supposed input output in response from related expression retrieving unit 332 to the supposed input of the training data sample to develop a new training data sample, and adds it to training data storage 84.

b. Training Data Adding Unit 334

Referring to FIG. 5, training data adding unit 334 has the following configuration. Training data adding unit 334 includes: a training data reading unit 360 that reads one by one the training data samples stored in training data storage 84 and extracts a word included in the result part of its causality; and a related expression query unit 362 that puts a query, to related expression retrieving unit 332, about a related expression for each of the words taken out by training data reading unit 360.

Training data adding unit 334 further includes a related expression adding unit 366 that receives the related expression output by related expression retrieving unit 332 in response to the query from related expression query unit 362, adds prescribed combinations of these to supposed inputs in the training data samples read by training data reading unit 360 and thereby generates new training data samples. Training data adding unit 334 further includes a training data writing unit 364 for additionally writing the new training data samples generated by related expression adding unit 366 to training data storage 84.

c. Topic Word Model 330

As described above, topic word model 330 is obtained by statistical processing of a prescribed corpus in advance such that when a word is given, it outputs a context word distribution vector having elements each representing probability of a specific word being generated around (for example, immediately before and after, or within two words before and after) the given word. The context word distribution vector has elements of which number corresponds to a prescribed number of words selected from the language of interest. From the context word distribution vector, words having high possibility of appearing near a word can be known. Further, the context word distribution vectors of words that appear in similar situations are similar. Therefore, words that appear in similar situations can also be estimated by using topic word model 330. To determine whether or not the two context word distribution vectors are similar to each other, cosine similarities of these may be used.

Other than the topic word model that calculates word embedding such as Word2Vec, it is also possible to employ a topic word model that fine-tunes pre-trained BERT model so as to estimate, for an input sentence, probability distribution of words appearing in the input sentence or sentences nearby.

d. Related Expression Retrieving Unit 332

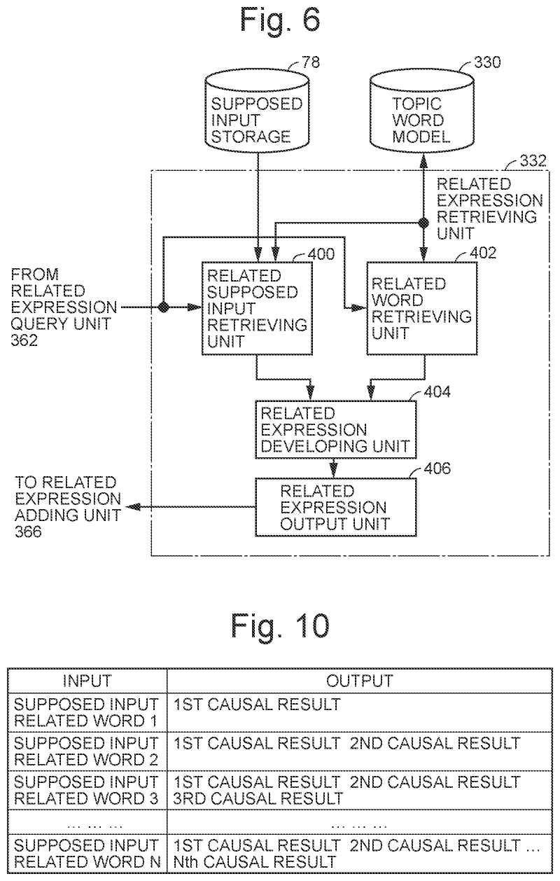

Referring to FIG. 6, related expression retrieving unit 332 includes a related supposed input retrieving unit 400 that receives, when a word is given from related expression query unit 362 shown in FIG. 5, context word distribution vector related to that word from topic word model 330, retrieves a supposed input including words having context word distribution vectors similar to that context word distribution vector from the supposed inputs stored in supposed input storage 78, and extracts them as a related supposed input. Related expression retrieving unit 332 further includes a related word retrieving unit 402 that obtains, when a word is given from related expression query unit 362, the context word distribution vector related to that word from topic word model 330, and from the context word distribution vector, selects a word having high possibility of being used around the input word as a related word. Related expression retrieving unit 332 further includes a related expression developing unit 404 for generating various combinations of the related supposed inputs extracted by related supposed input retrieving unit 400 and the related words selected by related word retrieving unit 402, and a related expression output unit 406 for outputting each of the combinations generated by related expression developing unit 404 to related expression adding unit 366 of FIG. 5.

### (3) Dialogue Apparatus 302

a. Configuration

Referring to FIG. 4, dialogue apparatus 302 includes a response generating neural network 340, which has the same configuration as response generating neural network 100 shown in FIG. 1, but different from response generating neural network 100, trained by expanded training data expanded by training data expansion unit 58. Dialogue apparatus 302 further includes an information adding device 338 that adds one or more words representing an expression uttered in the past by the user in the dialogue or representing a topic of the dialogue with the user, to the user input 102 to dialogue apparatus 302 and inputs the result to response generating neural network 340.

Information adding device 338 includes: a topic word model 344 similar to topic word model 330 of training data expansion unit 58; a user input storage 346 storing past user utterances; and a word selector 348 receiving user input 102, for extracting words included in user input 102 and selecting, with reference to topic word model 344, one or more words having high possibility of being related to the extracted words. Information adding device 338 further includes: an utterance selector 350 for selecting one or more utterances related to user input 102, from the user inputs stored in user input storage 346; and an information adding unit 352 for selecting (or not selecting), for user input 102, a combination of the words selected by word selector 348 and the user inputs selected by utterance selector 350, adding the selected combination to user input 102 and applying the result as an input to response generating neural network 340.

b. Topic Word Model 344

Topic word model 344 is the same as topic word model 330 of FIG. 4.

c. Word Selector 348

Word selector 348 extracts words included in user input 102, and obtains, for each of the words, the context word distribution vector with reference to topic word model 344. It has a function of selecting a word that corresponds to a prescribed number of elements having the highest probabilities among the context word distribution vectors.

d. User Input Storage 346

User input storage 346 stores, of the past user inputs, only a prescribed number of latest inputs. It may be helpful to add a time stamp to each user input.

e. Utterance Selector 350

Utterance selector 350 has a neural network that is pre-trained to receive a word vector sequence obtained by concatenating a user input 102 and a past user input stored in user input storage 346 with a prescribed separator token and to output a value representing the degree of relatedness between these, and it has a function of selecting a number of past user utterances of which values output from the neural network are the highest. If the time stamps of the user input is stored, the object of selection may be limited to user inputs of a predetermined time before current time to the current time, or the probability of selection of the user input may have a negative correlation with the time elapsed from when the input was made.

f. Information Adding Unit 352

Information adding unit 352 has a function of receiving all the words selected by word selector 348 and all the user utterances selected by utterance selector 350, generating a set of combinations of these, selecting one combination at random from the set, and adding it to user input 102. The combinations may include one not having any word or any past input. Therefore, outputs from information adding unit 352 may have various forms, such as user input 102 only, user input 102 +word, user input 102 +past input, user input 102 +two words, and user input 102 +word +past input.

### (4) Training Data Generating Program

a. Overall Configuration

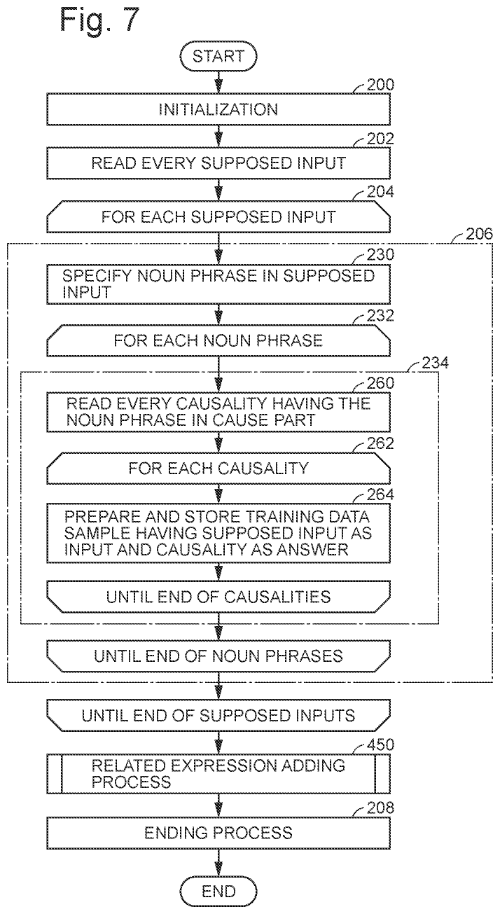

FIG. 7 shows a control structure of a program causing a computer to function as training data generator 54, training device 56 and training data expansion unit 58 shown in FIG. 4.

Referring to FIG. 7, the program differs from the first embodiment shown in FIG. 3 in that it includes, between steps 204 and 208, a step 450 of executing a process of adding, to user input 102, a related expression thereof.

b. Related Expression Adding Process

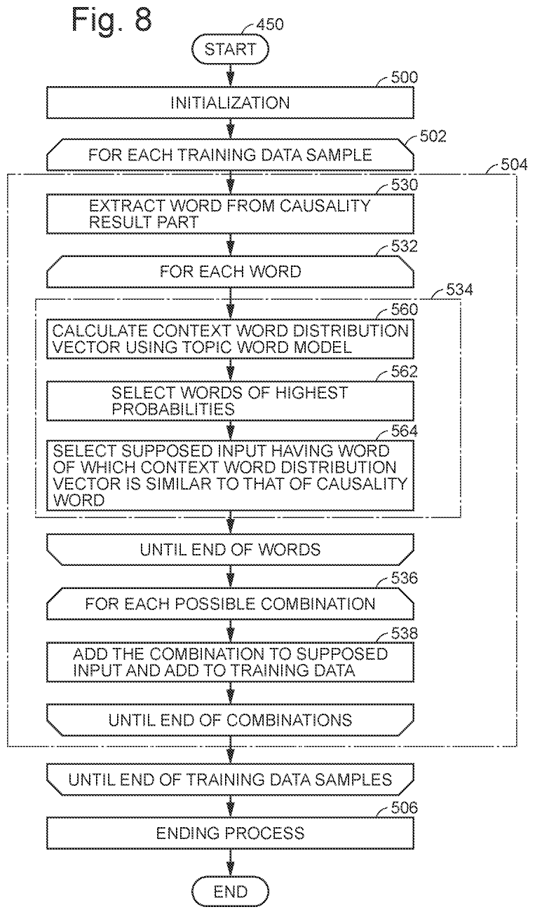

FIG. 8 shows a control structure of a program routine causing a computer to function to execute step 450 of FIG. 7.

Referring to FIG. 8, the routine includes: a step 500 of executing a prescribed initialization process at the start of execution of the routine; a step 502 of repeating the process of step 504, which will be described below, on each training data sample until the training data samples end; and a step 506 of executing a prescribed ending process after step 502 to complete execution of this routine and return to the main routine shown in FIG. 7.

Step 504 includes: a step 530 of extracting words from the result part of causalities included in training data samples to be processed; and a step 532 of repeating a step 534 on each word until the words extracted at step 530 ends, to generate a set of word candidates to be added to the supposed input. Step 504 further includes a step 536 executed after the completion of step 532, of executing step 538 where all possible combinations of the words included in the word set generated at step 532 are generated, and where each combination is added to the supposed inputs included in the training data sample to be processed, so as to generate new training data samples, which is added to the training data.

Step 534 includes: a step 560 of calculating the context word distribution vector of the word that is being processed, by using topic word model 330; and a step 562 of selecting a prescribed number of words having the highest probabilities calculated at step 560. Step 534 further includes a step 564 of selecting, based on the context word distribution vector calculated at step 560, a prescribed number of supposed inputs having such words that have similar context word distribution vectors as the context word distribution vector, from supposed input storage 78 of FIG. 4.

In this embodiment, at the time of word selection at step 562, the words are selected when the probability rankings of the words are high and their probabilities are also higher than a threshold. It is the same at step 564, and only the words of which similarity to the context word distribution vector is higher than a prescribed value are selected. The threshold values may be determined appropriately through experiments. Such limitations, however, are optional.

### 2 Operation

### (1) Creation of Training Data

a. Creation of Basic Training Data

Creation of basic training data is done from step 200 to step 204 of FIG. 7. The operation of the present embodiment here is the same as that of the first embodiment.

b. Expansion of Training Data

Expansion of training data is done at step 450 of FIG. 7. Specifically, referring to FIGS. 4 and 5, training data reading unit 360 of training data adding unit 334 reads training data one by one from training data storage 84 (step 502 of FIG. 8), extracts words from the result part of causalities in the training data (step 530), and applies them to related expression query unit 362. For each of these words (step 532), related expression query unit 362 puts a query, to related expression retrieving unit 332, about a related expression (step 534).

Referring to FIG. 6, when a word is given from related expression query unit 362, related supposed input retrieving unit 400 of related expression retrieving unit 332 calculates the context word distribution vector of the word from topic word model 330 (step 560). Based on the context word distribution vector, related word retrieving unit 402 selects a prescribed number of words having high probability of being used around the input word as related words (step 562). Related supposed input retrieving unit 400 further retrieves, from the supposed inputs stored in supposed input storage 78, supposed inputs including words having context word distribution vectors similar to the context word distribution vector, and takes them out as related supposed inputs (step 564). This process is performed for each word.

Related expression developing unit 404 generates possible combinations of the related supposed inputs taken out by related supposed input retrieving unit 400 and the related words selected by related word retrieving unit 402 (step 536). Related expression output unit 406 outputs each of the combinations generated by related expression developing unit 404 to related expression adding unit 366 shown in FIG. 5 as related expressions, which are related to causality.

Again referring to FIG. 5, related expression adding unit 366 receives the combinations of related expressions output from related expression retrieving unit 332, adds the combinations to the supposed inputs in the training data samples under processing, to generate new training data samples. Training data writing unit 364 additionally writes the new training data samples generated in this manner by related expression adding unit 366, to training data storage 84 (step 538).

Through the above-described process steps, the training data are expanded.

### (2) Training

Training of response generating neural network 340 in the second embodiment is the same as that of response generating neural network 100 of the first embodiment. It is noted, however, that the training data of the second embodiment is different from that of the first embodiment and, therefore, the parameters in response generating neural network 340 at the end of training are considerably different from the those in response generating neural network 100 of the first embodiment.

### (3) Dialogue Process

In the dialogue process, dialogue apparatus 302 operates in the following manner. First, when user input 102 is given to dialogue apparatus 302, word selector 348 extracts a word included in user input 102 and selects some words having high probability of being related to the word, with reference to topic word model 344. Utterance selector 350 selects some utterances related to the user input 102, from among past user inputs stored in user input storage 346. Information adding unit 352 selects, by any method, for example, at random, one of the combinations of words selected by word selector 348 and the user input selected by utterance selector 350 (including the case where none of them is selected), adds the selected one to user input 102, and applies the result as an input to response generating neural network 340.

Internal operation itself of response generating neural network 340 after receiving this input is the same as that of response generating neural network 100 of the first embodiment. It is noted, however, that these have different internal parameters and hence, even when the same user input 102 is given, it is highly possible that the output of response generating neural network 340 would be different from the output of response generating neural network 100. The possibility becomes higher when a word or the like is added to user input 102. Particularly, in generating an answer, response generating neural network 340 does not depend solely on user input 102, and it has high possibility of generating a response based on causality that has in the result part a word in the user input 102, or based on causality that has in the result part an expression related to a past user input preceding user input 102. Therefore, it is possible to provide with the user topics that are not expected by the user by reflecting latent chance or risk based on causality chains while sustaining the dialogue with the user.

By way of example, assume that user input 102 is “Artificial Intelligence has been developed, hasn't it?” Further assume that there is a past user input “I'm worried about elderly people.” and that this past user input is added to user input 102 and the resulting “Artificial Intelligence has been developed, hasn't it? +I'm worried about elderly people.” is applied to response generating neural network 340. In this case, response generating neural network 340 may possibly output “Let us utilize robots to provide care service and support the elderly”, which is a topic developed from user input 102 and leads the dialogue in a direction that is not expected by the user at the time of utterance of user input 102.

### 3 Effects

As described above, in the present embodiment, a response to a user input can be generated based on causality. In order to generate such a response, it is necessary to train the neural network by using a huge number of causality expressions. Different from common dialogue data, a huge amount of causality expressions can easily be collected from the Internet, and the amount keeps increasing day by day. Therefore, it is easy to improve accuracy of generating responses by the neural network to be used for dialogue. Further, since responses are generated based on causality, different from the dialogue systems using conventional neural networks, responses based on latent chances and risks that the user is unaware of can be generated by reflecting the causality and causality chains. As a result, dialogue with the user can be developed in more fruitful manner than in the past.

### III. Third Embodiment

### 1 Configuration

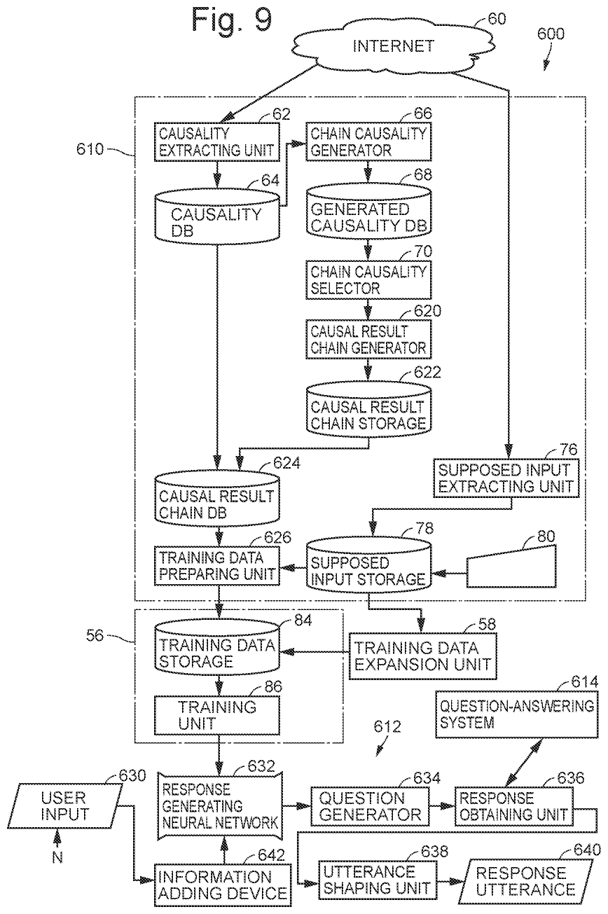

FIG. 9 is a block diagram showing a configuration of dialogue system 600 in accordance with the third embodiment of the present invention. Referring to FIG. 9, dialogue system 600 includes: a training data generator 610 for generating training data for the dialogue system; and a dialogue apparatus 612 including a neural network. Dialogue system 600 further includes: a training data expansion unit 58 that prepares and adds new training data samples to each training data sample prepared by training data generator 610, by adding some word/phrase related to its supposed input as a topic to the supposed input, which is the same as the one shown in FIG. 4; and a training device 56 for training dialogue apparatus 612 using the training data generated by training data generator 610 and expanded by training data expansion unit 58.

The training data generator 610 is different from training data generator 54 shown in FIG. 1 in; that it includes, following chain causality selector 70 of FIG. 1, a causal result chain generator 620 that generates a character sequence (here, referred to as a causal result chain) by taking out, from each of the chain causalities selected by chain causality selector 70, the cause part of the head causality and only the result part of the causalities included in the chain causality and linking these successively; that it includes, in place of chain causality DB 72 of FIG. 1, causal result chain storage 622 for storing causal result chain generated by causal result chain generator 620; and that it includes, in place of expanded causality DB 74 shown in FIG. 1, a causal result chain DB 624 for storing lone causalities stored in causality DB 64 as well as causal result chains stored in causal result chain storage 622. A single causality stored in causality DB 64 can be regarded as a causal result chain of which number of causal results is only one. Training data generator 610 is further different from training data generator 54 shown in FIG. 1 in that it includes, in place of training data preparing unit 82 shown in FIG. 1, a training data preparing unit 626 for preparing training data for training dialogue apparatus 612 by using the causal result chains stored in causal result chain DB 624 and the supposed inputs stored in supposed input storage 78.

The third embodiment differs from the first and second embodiments in that the user inputs a user input 630 to dialogue apparatus 612 while designating a natural number N that designates the number of causal result chains.

Dialogue apparatus 612 includes: a response generating neural network 632 trained by training device 56; and an information adding device 642, including topic word model 344, word selector 348 and information adding unit 352 in information adding device 338 shown in FIG. 4, that receives user input 630, extracts words representing a topic of the dialogue with the user, adds arbitrary combinations of these words to user input 630 and inputs the results to response generating neural network 632. The added arbitrary combinations of words are inserted between user input 630 and the natural number N. Specifically, the input to response generating neural network 632 has a form of “user input 630”+“combination of words added by information adding device 338”+“natural number N designating the number of linkages.” As will be described later, response generating neural network 632 is trained such that when an input in this form is applied, it outputs a character sequence consisting of N causal result chains including, at the last causal result chain, any of the words added by information adding device 338.

Dialogue apparatus 612 further includes: a question generator 634 for generating a question from the result of output from response generating neural network 632 to the input given from information adding device 338; a response obtaining unit 636 applying the question generated by question generator 634 to an external question-answering system 614 and obtaining its response; and an utterance shaping unit 638 for shaping the response obtained by response obtaining unit 636 to be a dialogue sentence and outputs as a response utterance 640.

In this embodiment (as well as in other embodiments), in the process by question generator 634, an interrogative is added to the head of causality expression output from response generating neural network 632, and the tail end is shaped to some question form, so that a question sentence is created. For the preparation of question sentences, a separately trained neural network or some rule-based shaping means may be used.

By way of example, assume that the causality expression output from response generating neural network 632 is “to go to Nara”->“to meet deer.” By adding (1) “How” to this causality expression, a question sentence “How to go to Nara to meet deer?” is prepared. By further adding to this result (2) “well,” another question sentence “How to go to Nara to meet deer well?” is created.

Response obtaining unit 636 inputs either one or both of these question sentences to question-answering system 614 and obtains an answer as an output as well as text extracting the answer. Utterance shaping unit 638 utilizes this answer on its own or in combination with the text from which the answer is extracted, shapes it to be an appropriate response in the dialogue with the user, and outputs a final response utterance 640.

As question-answering system 614 here, we assume a system that performs search and retrieval of internal database or external information source (for example, documents on the Internet) based on the input, and extracts and outputs as a response, a description that is recognized as related to the input question and based on a fact or well grounded. An example of such question-answering system is Question-Answering System WISDOM X (https://www.wisdom-nict.jp/) operated by National Institute of Information and Communications Technology. By cascading such a question-answering system 614, it becomes possible to use supporting descriptions and text in the process of generating a response, and hence, it becomes possible to provide a basis for the response utterance 640 to the user. It is possible to use outputs of a typical search engine other than WISDOM X.

As described above, since the input to response generating neural network 632 has the form of “user input 630”+“combination of utterances and words added by information adding device 338”+“natural number N designating the number of linkages,” training data such as shown in FIG. 10 is necessary for training response generating neural network 632.

Referring to FIG. 10, each of the training samples forming the training data has “supposed input+related word (words)+natural number N” as the input, and includes as an output a causal result chain consisting of the causal results of which number is the number designated by natural number N. Here, the causal result at the tail end of the output of each training sample includes any of the words of the related word (words).

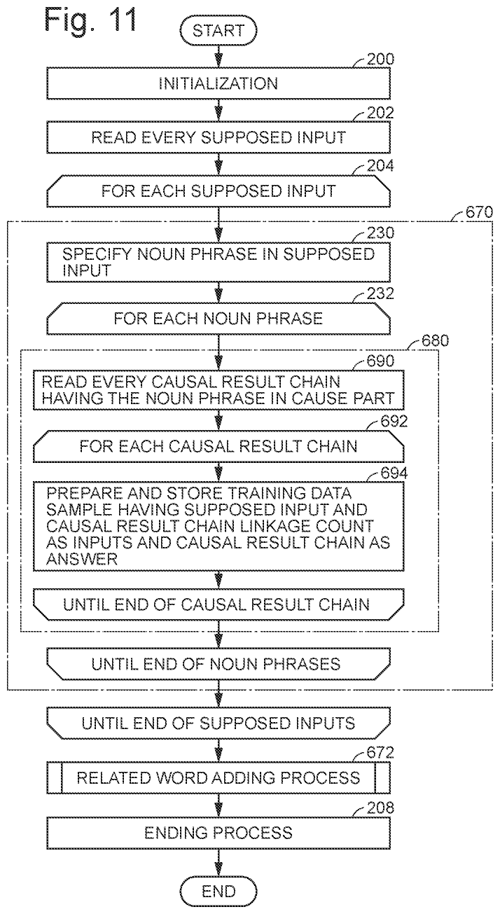

FIG. 11 is a flowchart showing a control structure of the computer program causing a computer to function as training data preparing unit 626 shown in FIG. 9. Referring to FIG. 11, the program is similar to the one in accordance with the second embodiment shown in FIG. 7. The program shown in FIG. 11, however, differs from that of FIG. 7 in that it includes a step 670 in place of step 206 of FIG. 7 and that it includes a step 672 of adding a related word and not a related expression to the input, in place of step 450 of FIG. 7.

Step 670 is similar to step 206 of FIG. 7. Step 670, however, differs from step 234 in that it includes a step 680 in place of step 234 of FIG. 7.

Step 680 includes: a step 690 of reading all causal result chains having at the cause part (head of causal result chain) the noun phrase that is being processed; and a step 692 of executing a step 694 on each of the causal result chains read at step 690.

Step 694 is to prepare and save, for the combination of supposed input and causal result chain under processing, a training data sample having the supposed input and the number of the causal result chain as inputs and having the causal result chain as an output.

Specifically, by the process of step 680, training data samples having “related word (words)” removed from the training data samples shown in FIG. 10 can be obtained. The “related word (words)” will be added at step 672.

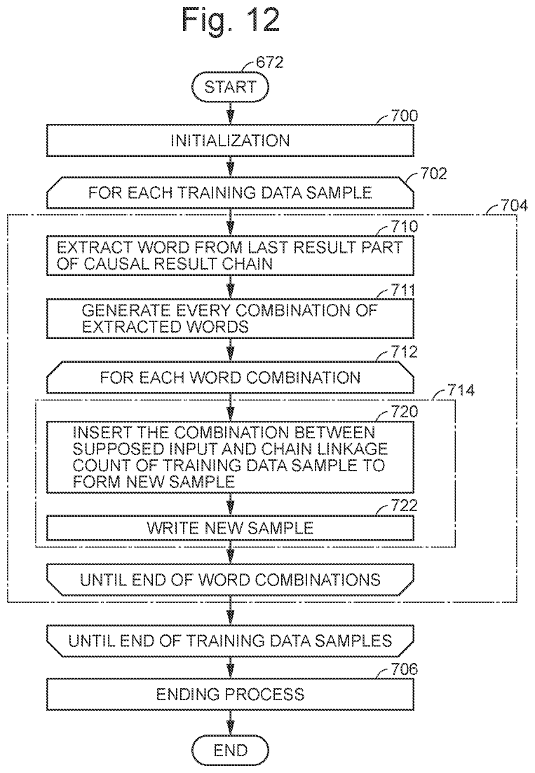

FIG. 12 shows a control structure of a program routine realizing step 672 of FIG. 11. Referring to FIG. 12, the program includes: a step 700 of executing a prescribed initialization process: a step 702 of executing a step 704 on each training data sample; and a step 706 of ending, after step 702, execution of the routine by a prescribed ending process.

Step 704 includes: a step 710 of extracting words from the last result part of causality chain of the training data sample under processing; a step 711 of generating every possible combination of the words extracted at step 710; and a step 712 of executing a step 714 on each of the combinations generated at step 711.

Step 714 includes: a step 720 of inserting the combination of words that is being processed between the supposed input of training data sample under processing and the natural number N indicating the number of linkages, and thereby generating a new sample; and a step 722 of writing the new sample created at step 720 to training data storage 84 shown in FIG. 9 and ending execution of step 714.

### 2 Operation and Effects

By causing a computer to execute the program of which control structure is shown in FIGS. 11 and 12, training data having such a configuration as shown in FIG. 10 can be obtained. It should be noted here that the word (words) in the “related word (words)” of input column of training data is included in the causal result at the tail end of the causal result chain as the output, and that the number of causal results at the output column is the number designated by the natural number of the input column.

Using thus prepared training data, response generating neural network 632 shown in FIG. 9 is trained. As a result, parameters of response generating neural network 632 will be set such that when an input having the structure indicated as “input” in FIG. 10 is applied to response generating neural network 632, response generating neural network 632 outputs a causal result chain that has a cause part related to the supposed input designated by the input, has causal results in the number designated by the input, and has a related word or a word close to the related word designated by the input as the last causal result.

Therefore, when the user inputs a user input 630 and a natural number N to dialogue apparatus 612 for an actual inference, a word indicating the topic of dialogue is selected as a related word for user input 630 and added to the input. When this input is given to response generating neural network 632, response generating neural network 632 outputs a causal result chain having the designated number of causal results and including in the causal result at the tail end the word designated as the related word or a word close to that word. Its cause part relates to the input. The causal result chain is the “causality expression” as mentioned in the first and second embodiments. From the causality expression, question generator 634 generates a question sentence. Response obtaining unit 636 applies the question sentence to question-answering system 614 and obtains a response therefrom. Utterance shaping unit 638 shapes the response to a shape appropriate as a response to user input 630, and outputs the result as response utterance 640.

In the present embodiment, user input+related word+natural number N are input to response generating neural network 632, and a plurality of causal result chains each consisting of N causal results are obtained. By way of example, assume that “Artificial Intelligence develops” is given as a user input, and a word “elderly” is found as the related word. If we assume 1, 2 and 3 as the value of natural number N, the outputs would be as follows.

N=1: Support the elderly.

N=2: Utilize robots.->Support the elderly.

N=3: Utilize robots.->Care service is available.->Support the elderly.

Therefore, the value of natural number N brings about the effect of clarifying details between the input and the final result. Specifically, response utterance 640 includes the user-designated number of causal results existing between the input and the output. Therefore, results not even expected by the user when the user issues user input 630, including process of development thereof, can be obtained. In other words, the process of thinking of dialogue apparatus 612 in the dialogue becomes clear, which builds a momentum for developing the dialogue.

At the time of generation, an additional word from information adding device 642 is not always input to response generating neural network 632, and it may be omitted.

### IV. Fourth Embodiment

### 1 Configuration

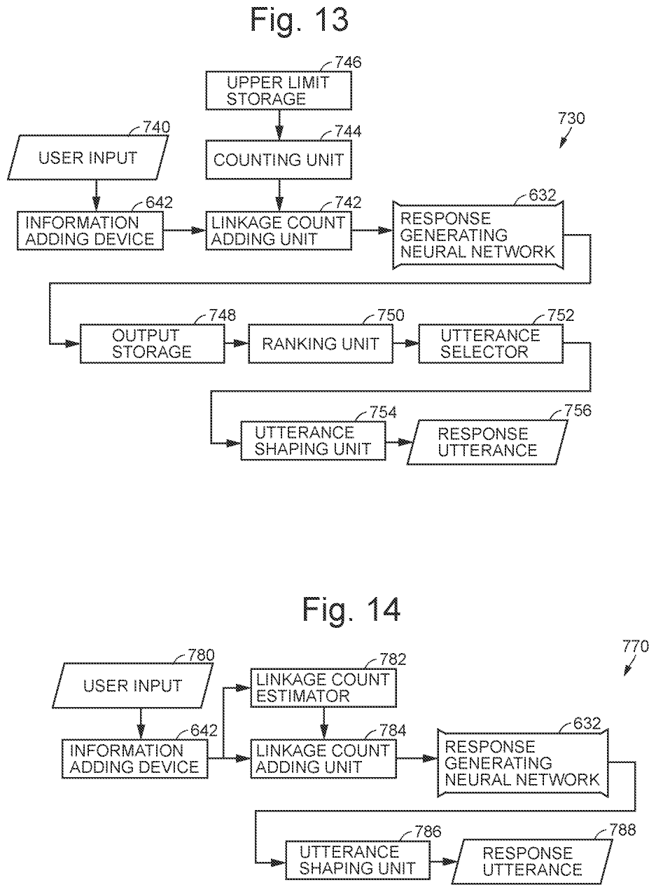

By using response generating neural network 632 trained in the third embodiment, the following embodiment is also possible. FIG. 13 shows a configuration of dialogue apparatus 730 in accordance with the fourth embodiment.

Referring to FIG. 13, dialogue apparatus 730 includes: the above-described response generating neural network 632; and information adding device 642 receiving a user input 740 for adding a related word (words) indicating a topic to the user input 740 and outputting the result. Dialogue apparatus 730 further includes a linkage count adding unit 742 for adding, to the output of information adding device 642, the natural number N applied from the outside as indicating the count of linkages of causal results described in the third embodiment, and inputting the result to response generating neural network 632. Dialogue apparatus 730 further includes: an upper limit storage 746 storing the upper limit of linkage count; and a counting unit 744 for incrementing the natural number N one by one starting from 1 to the upper limit stored in upper limit storage 746 and for applying N to linkage count adding unit 742 causing linkage count adding unit to sequentially output the output of information adding device 642 having the natural number N appended.

Dialogue apparatus 730 further includes: an output storage 748 storing a series of causal result chains successively output from response generating neural network 632 in response to these inputs; and a ranking unit 750 for ranking the series of causal result chains stored in output storage 748. Dialogue apparatus 730 further includes: an utterance selector 752 for selecting the highest ranked causal result chain ranked by ranking unit 750 as an utterance candidate; and an utterance shaping unit 754 for shaping the causal result chain selected by utterance selector 752 to be an appropriate response to user input 740 and outputting the result as a response utterance 756.

As the ranking unit 750, a pre-trained neural network may be used. For training the neural network, sets of causal result chains for the combinations of user inputs and related words evaluated manually may be used.

### 2 Effects

The present embodiment has the following effects. For example, assume that there is an input “Artificial Intelligence develops,” and “elderly” is selected as the additional word. While the final result is “support the elderly,” there may be a chain including a plurality of causal results. The number of the causal results, however, is not known in advance. In the present embodiment, however, for each number in the range of natural numbers entered, causal result chain including that number of causal results are generated, and the one having the highest rank among these can be output as the response utterance 756. As a result, even a causal result not at all expected by the user at the time of utterance of user input 740 but is appropriate as a response can be selected.

The number of chains of causal results at the inference may not be limited to the natural number N of data at the training. For example, if the natural number N of training data is at most 10, the natural number N at the inference may not be limited to 10. As long as a prescribed accuracy can be obtained, the inference process may be executed while setting the natural number N to, for example, 15.

### V. Fifth Embodiment

### 1 Configuration

In the fourth embodiment above, a plurality of causal results generated for a plurality of natural numbers N are evaluated a posteriori, and the one having the highest score is selected. The present invention, however, is not limited to such an embodiment. Similar evaluation may be conducted in advance and the results may be used for the dialogue system. The fifth embodiment is directed to such an example. Specifically, in this example, for each combination of a supposed input and a related word, a plurality of causal result chains consisting of 1 to N causal results are created in advance manually or by using response generating neural network 632 of the fourth embodiment. The results are ranked manually. Then, training data is created, which has a combination of a supposed input and its related word as an input and has the natural number N that leads to the highest ranked one among the causal result chains derived from the combination as correct data. By using such training data, a neural network that outputs the natural number N upon receiving a user input (N-evaluation neural network) is trained. By inputting an input and a related word to the trained N-evaluation neural network, the natural number N is obtained, and by giving “input+related word+N” to a response generating neural network, an output is obtained.

Specifically, referring to FIG. 14, a dialogue system 770 in accordance with the fifth embodiment includes: an information adding device 642 adding a related word to user input 780; and a linkage count estimator 782 including the above-described N-evaluation neural network, obtaining the output of information adding device 642 and outputting the optimal value of natural number N for the combination of user input and related word included in the obtained output. Dialogue system 770 further includes a linkage count adding unit 784, further adding, to the output of information adding device 642, the natural number N as the linkage count output by linkage count estimator 782.

Dialogue system 770 further includes: response generating neural network 632 receiving the user input, related word and natural number N output from linkage count adding unit 784 as an input and outputting causal result chains including the designated N causal results; and an utterance shaping unit 786 that performs shaping of the causal result chain output from response generating neural network 632 to be appropriate as a response to user input 780 and outputting as a response utterance 788.

### 2 Effects

According to the fifth embodiment, if the user simply inputs (utters) user input 780, dialogue system 770 estimates a related word, and linkage count estimator 782 estimates the natural number N, and these are applied to response generating neural network 632. Therefore, it is unnecessary for the user to think about the related word or to specify the natural number N. From response generating neural network 632, an appropriate response utterance 788 is obtained and, in addition, the user can easily understand what represents the thought process of dialogue system 770 from the causal result in the response utterance 788. As a result, the dialogue by dialogue system 770 can be developed in a meaningful manner for the user.

In the third, fourth and fifth embodiments above, it is assumed that the causal result at the tail end includes a word designated as the related word or a word close to that word. This is not essential, and any sample in which the result chain does not include an expression representing the topic may be used for learning.

### VI. Computer Implementation

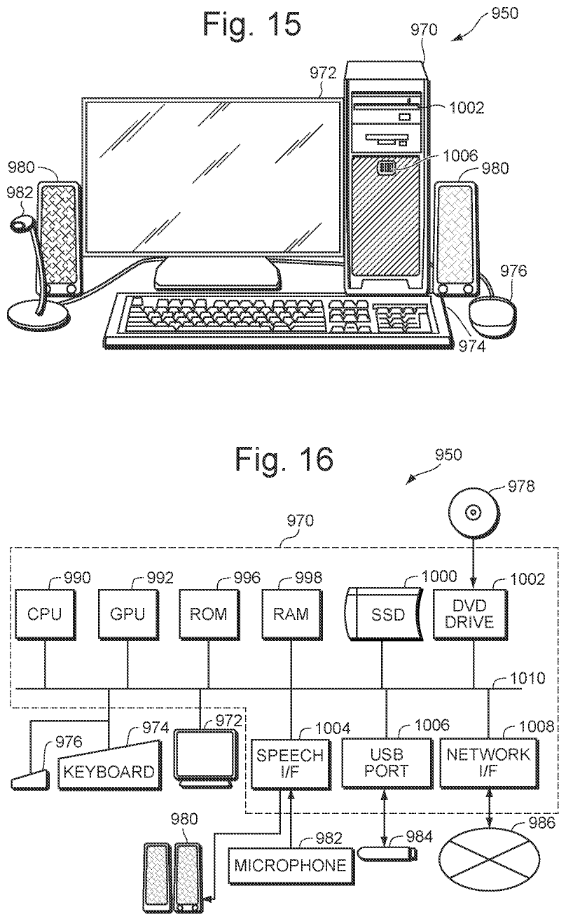

FIG. 15 shows an appearance of a computer system realizing the above-described embodiments, and FIG. 16 is a hardware block diagram of the computer system shown in FIG. 15.

Referring to FIG. 15, computer system 950 includes: a computer 970 having a DVD (Digital Versatile Disc) drive 1002; and a keyboard 974, a mouse 976 and a monitor 972, all connected to computer 970 for interaction with the user. These are examples of equipment for allowing user interaction, and any other general hardware and software (for example, a touch-panel, voice input, pointing device and so on) allowing user interaction may be used.

Referring to FIG. 16, computer 970 includes, in addition to DVD drive 1002, a CPU (Central Processing Unit) 990, a GPU (Graphics Processing Unit) 992, and a bus 1010 connected to CPU 990, GPU 992, and DVD drive 1002. Computer 970 further includes: a ROM (Read-Only Memory) 996 connected to bus 1010 for storing a boot up programs and the like of computer 970; a RAM (Random Access Memory) 998 connected to bus 1010, for storing program instructions, a system program and work data; and an SSD (Solid State Drive) 1000, which is a non-volatile memory connected to bus 1010. SSD 1000 is for storing programs executed by CPU 990 and GPU 992, data used by the programs executed by CPU 990 and GPU 992 and so on. Computer 970 further includes a network I/F (Interface) 1008 providing connection to a network 986 allowing communication with other terminals; and a USB (Universal Serial Bus) port 1006 to which a USB memory 984 may be detachably attached, providing communication with USB memory 984 and different units in computer 970.

Computer 970 further includes: a speech I/F 1004 connected to a microphone 982, a speaker 980 and bus 1010. Speech I/F 1004 is for reading out a speech signal, a video signal and text data generated by CPU 990 and stored in RAM 998 or SSD 1000 under the control of CPU 990, to convert it into an analog signal, amplify it, and drive speaker 980, or for digitizing an analog speech signal from microphone 982 and storing it in addresses in RAM 998 or in SSD 1000 specified by CPU 990.

Programs for realizing the dialogue systems 50, 300, 600 and 770 or training data generators 54 and 610, training device 56, dialogue apparatuses 52, 302, 612 and 730 as well as training data expansion unit 58 as parts of the systems, neural network parameters and neural network programs, and training data, causalities, causal result chains and related inputs are stored, for example, in SSD 1000, RAM 998, DVD 978 or USB memory 984, or to a storage of an external device, not shown, through network I/F 1008 and network 986, each shown in FIG. 16, for example. Typically, the data and parameters are written from the outside to SSD 1000, for example, and at the time of execution by computer 970, loaded into RAM 998. In some cases, part of the codes executed by the program may be loaded from outside of computer 970 through network 986 to RAM 998 at the time of execution.

Computer programs causing the computer system to operate to realize functions of the systems in accordance with the above-described embodiments and components thereof are stored in DVD 978 loaded to DVD drive 1002, and transferred from DVD drive 1002 to SSD 1000. Alternatively, these programs may be stored in USB memory 984, which may be inserted to USB port 1006, and the programs may be transferred to SSD 1000. Alternatively, the programs may be transmitted through network 986 to computer 970 and stored in SSD 1000.

At the time of execution, the programs will be loaded into RAM 998. Naturally, source programs may be input using keyboard 974, monitor 972 and mouse 976, and the compiled object programs may be stored in SSD 1000. When a script language is used, scripts input through keyboard 974 or the like may be stored in SSD 1000. For a program operating on a virtual machine, it is necessary to install programs that function as a virtual machine in computer 970 beforehand. Since training and tests of neural networks involve huge amount of computation, it is preferable to realize various components of the embodiments through object program consisting of computer native codes, rather than the script language.

CPU 990 fetches an instruction from RAM 998 at an address indicated by a register therein (not shown) referred to as a program counter, interprets the instruction, reads data necessary to execute the instruction from RAM 998, SSD 1000 or from other device in accordance with an address specified by the instruction, and executes a process designated by the instruction. CPU 990 stores the resultant data at an address designated by the program, of RAM 998, SSD 1000, register in CPU 990 and so on. At this time, the value of program counter is also updated by the program. The computer programs may be directly loaded into RAM 998 from DVD 978, USB memory 984 or through the network. Of the programs executed by CPU 990, some tasks (mainly numerical calculation) may be dispatched to GPU 992 by an instruction included in the programs or in accordance with a result of analysis during execution of the instructions by CPU 990.

The programs realizing the functions of the systems and their various units in accordance with the above-described embodiments by computer 970 may include a plurality of instructions described and arranged to cause computer 970 to operate to realize these functions. Some of the basic functions necessary to execute the instruction are provided by the operating system (OS) running on computer 970, by third-party programs, or by modules of various tool kits installed in computer 970. Therefore, the programs may not necessarily include all of the functions necessary to realize the system and method in accordance with the present embodiment. The programs have only to include instructions to realize the functions of the above-described various devices or their components by statically linking or dynamically calling appropriate functions or appropriate “program library” in a manner controlled to attain desired results. The operation of computer 970 for this purpose is well known and, therefore, description thereof will not be repeated here.

It is noted that GPU 992 is capable of parallel processing and capable of executing a huge amount of calculation accompanying machine learning simultaneously in parallel or in a pipe-line manner. By way of example, parallel computational element found in the programs during compilation of the programs or parallel computational elements found during execution of the programs may be dispatched as needed from CPU 990 to GPU 992 and executed, and the result is returned to CPU 990 directly or through a prescribed address of RAM 998 and input to a prescribed variable in the program.

### VII. Modifications

In the embodiments, causalities collected from the Web are directly used, and as to the expanded causalities, only the appropriate ones are used. The present invention, however, is not limited to such embodiments. By way of example, causalities to be used for training may be filtered in some way. As an example, causalities of which sentiment polarity is positively biased or negatively biased may be used. Only the causalities of which affinity to a specific topic have been found by the topic word model may be used. Whether or not the causality is apt as a response in a dialogue may be manually or automatically labelled, and only the ones determined to be apt may be used.

The neural network used in the embodiment above is a pre-trained neural network (for example, the above-described BERT) fine-tuned by using training data prepared based on causality. The neural network, however, is not limited to this type. For example, one that provides causal result by giving an input of a special form, such as GPT-3 described in the article below, may be used. Reference: Tom B. Brown et al., Language Models are Few-Shot Learners, https://arxiv.org/pdf/2005.14165.pdf

At the time of generating a response, by way of example, a user input may be repeated to further modify the sentence-end expression and the like by a rule or neural network based on deep learning, to return a response. In accordance with the user's utterance or reply to the response of the dialogue system, further causality may be traced and the consequence may be presented in the form of a response. Training data for interpreting the user's utterance or reply here may be separately created, and determined by a neural network trained by deep learning. If a user responds negatively to the dialogue system's response, a why-type question-answering may be given and, further, a causality having the expression used in the response in the result part may be searched and its cause part may be presented. Similarly, the process of response generation may be explained to the user.

On the contrary, if the user responds positively to the dialogue system's response, again, a causality having the expression used in the response in the result part may be searched, and a response may be generated from the cause part.

Further, in the second to fifth embodiments, a word or supposed input is added to user input 102, 630, 740 or 780. The present invention, however, is not limited to such embodiments. A combination of a word and supposed input to be added may be converted to a feature vector of a fixed length by using an encoder implemented by a neural network, and user input 102, 630, 740 or 780 having the feature vector added may be used as an input to response generating neural network 340, 632.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

### REFERENCE SIGNS LIST

50, 300, 600, 770 dialogue system

52, 302, 612, 730 dialogue apparatus

54, 610 training data generator

56 training device

58 training data expansion unit

60 Internet

62 causality extracting unit

64 causality DB

66 chain causality generator

68 generated causality DB

70 chain causality selector

72 chain causality DB

74 expanded causality DB

76 supposed input extracting unit

78 supposed input storage

80 console

82, 626 training data preparing unit

84 training data storage

86 training unit

100, 340, 632 response generating neural network

102, 630, 740, 780 user input

104, 638, 754, 786 utterance shaping unit

106, 640, 756, 788 response utterance

150 supposed input reading unit

152 noun phrase specifying unit

154 causality retrieving unit

156 training data sample preparing unit

330, 344 topic word model

332 related expression retrieving unit

334 training data adding unit

338, 642 information adding device

346 user input storage

348 word selector

350, 752 utterance selector

352 information adding unit

360 training data reading unit

362 related expression query unit

364 training data writing unit

366 related expression adding unit

400 related supposed input retrieving unit

402 related word retrieving unit

404 related expression developing unit

406 related expression output unit

614 question-answering system

620 causal result chain generator

622 causal result chain storage

624 causal result chain DB

634 question generator

750 ranking unit

782 linkage count estimator

1. A training device for a dialogue apparatus, comprising:
a supposed input storage means for storing a plurality of supposed inputs each being supposed as an input to the dialogue apparatus; and
a causality storage means for storing a plurality of causality expressions; wherein
each of said plurality of causality expressions includes a cause expression and a result expression;
for each of said plurality of supposed inputs stored in said supposed input storage means,
said training device comprising:
a causality expression extracting means for extracting, from said plurality of causality expressions, a causality expression having a prescribed relation as said supposed input,
a training data preparing means for creating a training data sample having said supposed input as an input and the causality expression extracted by said causality expression extracting means as an answer, and storing it in a prescribed storage device; and
a training means for training a dialogue apparatus implemented by a neural network designed to generate an output sentence to an input sentence in a natural language, by using the training data samples stored in said training data preparing means.

2. The training device according to claim 1, wherein
said causality expression extracting means includes a specific causality expression extracting means for extracting, from said plurality of causality expressions, a causality that its cause expression has a noun phrase of said supposed input in its cause expression.

3. The training device according to claim 1, further comprising:
a topic word model pre-trained such that when a word is given, context word distribution probability of the word is output for each of the words in a predefined lexicon; and
a first training data sample adding means for specifying, for each of the causality expressions of the training data samples stored in said prescribed storage device, a word having a high distribution probability for the word included in the causality expression based on outputs of the topic word model, adding the specified word to said input of said training data sample to generate a new training data sample and adding it to said prescribed storage device.

4. The training device according to claim 3, further comprising
a second training data sample adding means, extracting, based on an output of said topic word model, for each of the causality expressions of the training data sample stored in said prescribed storage device, a sentence having a context word distribution probability similar to the context word distribution probability of the causality expression from a prescribed corpus, adding the extracted sentence to said input of said training data sample to generate a new training data sample and adding it to said prescribed storage device.

5. A natural language dialogue apparatus, comprising a neural network designed to generate an output sentence to a natural language input sentence, wherein
said neural network is trained such that said output sentence represents a latent result to said input sentence.

6. The dialogue apparatus according to claim 5, further comprising
a related expression adding means, responsive to an input sentence, for adding a related expression, which includes a word or sentence related to said input sentence, to said input sentence and inputting to said neural network.

7. A dialogue apparatus, comprising:
an utterance storage storing a past utterance of a user;
a topic model for outputting context word occurrence probability distribution with respect to the input word; and
a response generator receiving a user utterance as an input, for generating a response to the user utterance by using user utterances stored in said utterance storage and the topic model.

8. A dialogue apparatus, comprising:
an utterance storage storing a past utterance of a user;
a topic model for outputting context word occurrence probability distribution with respect to the input word; and
a response generator receiving a user utterance as an input, for generating a response to the user utterance; and
a response adjuster adjusting generation of said response by said response generator in accordance with an output of said topic model in response to said user utterance.
